(19) United States
(12) Patent Application Publication
(10) Pub. No.: US 2015/0074032 A1
(43) Pub. Date: Mar. 12, 2015

(54) METHOD AND SYSTEM FOR ENTITY BASED POSITION ASSIGNMENT

(71) Applicant: DESIRE2LEARN INCORPORATED, Kitchener (CA)

(72) Inventors: Stefan REGEHR, Kitchener (CA); Scott WILLIAMS, Kitchener (CA); Brian PEARSON, Kitchener (CA); Steven LOW, Kitchener (CA)

(73) Assignee: DESIRE2LEARN INCORPORATED, Kitchener (CA)

(21) Appl. No.: 14/025,147

(22) Filed: Sep. 12, 2013

(51) Int. Cl. G06N 5/02

(52) U.S. Cl. CPC G06N 5/02
USPC 706/46

(57) ABSTRACT

A method and system for entity based position assignment are provided. The method includes: retrieving position data related to each position of a plurality of positions; retrieving data related to each entity of a plurality of entities, wherein each entity is to be assigned to one of the plurality of positions; determining a desirable arrangement based at least in part on the position data and the entity data; and arranging each entity in a corresponding desired position within the desirable arrangement. The system includes: a position module configured to retrieve position data relating to each position of a plurality of positions; an entity module configured to retrieve entity data relating to each entity of a plurality of entities, wherein each entity is to be assigned to a position; and a data analysis module configured to determine a desirable arrangement based at least in part on the position data and the entity data and further configured to arrange each in a corresponding desired position within the desirable arrangement.

### FIELD

The present disclosure relates generally to position assignment. More particularly, the present disclosure relates to methods and systems for entity based position assignment.

### BACKGROUND

In many areas, position assignment, placing various entities in specific positions, is required. For example, in a classroom setting, an instructor typically arranges students in particular seating arrangements in order to obtain a distribution that pleases the instructor. Typically, the instructor tries to ensure that students are able to have appropriate access to the classroom amenities and may have to manually rearrange the class seating arrangement periodically in order to optimize the seating arrangement. Similar situations may further incur in a business environment, where certain amenities are more easily accessible from certain positions.

In some cases, positions arrangements or assignments may be required for inanimate objects, for example plant position in a nursery may be crucial to whether the plant survives or thrives. Conventionally, trial and error and reorganization is necessary in order to obtain a desirable arrangement in which entities are located in appropriate positions.

It is, therefore, desirable to provide an improved method and system for entity based position assignment.

The above information is presented as background information only to assist with an understanding of the present disclosure. Not determination has been made, and no assertion is made, as to whether any of the above might be applicable as prior art with regard to the present disclosure.

### SUMMARY

In a first aspect, the present disclosure provides a method for assigning positions, the method including: retrieving position data related to each position of a plurality of positions; retrieving data related to each entity of a plurality of entities, wherein each entity is to be assigned to one of the plurality of positions; determining a desirable arrangement based at least in part on the position data and the entity data; and arranging each entity in a corresponding desired position within the desirable arrangement.

In a particular case, the method may further include a position weighting for each of the plurality of positions.

In another particular case, the determining of the desirable arrangement may include: determining rules corresponding to the entity data and position data; and determining a desirable arrangement based on the rules.

In yet another particular case, the position data may be based on at least one of: location of each position; proximity to equipment; and accessibility of each position.

In still another particular case, each entity may be an individual. In this case, the entity data may be based on at least one of: individual preferences; individual attributes; individual special requirements; individual achievements; individual attendance; and individual participation.

In a particular case, the desirable arrangement may be a diversified arrangement. In some cases, the diversified arrangement includes entities with similar entity status scattered throughout the corresponding positions in the desirable arrangement.

In another particular case, the desirable arrangement may be an arrangement in which special requirement criteria are met.

In yet another particular case, the method may also include allowing a user to edit the desirable arrangement.

In still yet another particular case, the method may also include displaying the desirable arrangement on a network enabled device.

In a further aspect there is provided a system for entity based position assignment, the system including: a position module configured to retrieve position data relating to each position of a plurality of positions; an entity module configured to retrieve entity data relating to each entity of a plurality of entities, wherein each entity is to be assigned to a position; and a data analysis module configured to determine a desirable arrangement based at least in part on the position data and the entity data and further configured to arrange each in a corresponding desired position within the desirable arrangement.

In a particular case, the data analysis module may be further configured to determine a position weighting for each of the plurality of positions based on the position data.

In another particular case, the system may further include a rule engine configured to determine rules corresponding to the position data and the entity data, wherein the rules may be used in determining the desirable arrangement.

In yet another particular case, the data analysis module may be further adapted to arrange each entity into a position based on the desirable arrangement.

In still another particular case, the position module further may include an input component adapted to collect position data and store the position data in a database.

In still yet another particular case, the entity module further may include an input component adapted to collect the entity data store the entity data in a database.

In another particular case, the system may include a display module adapted to display the desirable arrangement on a network enabled device.

In a further aspect, there is provided a system for automated seat arrangement in a classroom, the system including: a position module adapted to capture data relating to seating positions in the classroom; an entity module adapted to capture data relating to students in the classroom; a data analysis module adapted to determine a desirable seating arrangement based at least in part on the data relating to seating positions and the data relating to the students.

In a particular case, the data analysis module may be further configured to determine a position weighting for each seating position based on the data relating to seating positions in a class room.

In yet another particular case, the system may include a rule engine configured to determine rules corresponding to the data relating to seating positions in a class room and the data relating to the students in the classroom, wherein the rules may be used in determining the desirable seating arrangement.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates an example of a system for entity based position assignment according to an example embodiment;

FIG. 2 illustrates an example of a method for entity based position assignment according to an example embodiment;

FIG. 3 illustrates a system for entity based position assignment in a classroom example according to an example embodiment;

FIG. 4 illustrates position data according to a system for entity based position assignment such as, for example, the system illustrated in FIG. 3;

FIG. 5 illustrates rule generation according a system for entity based position assignment such as, for example, the system illustrated in FIG. 3; and

FIG. 6 illustrates entity organization a system for entity based position assignment such as, for example, the system illustrated in FIG. 3.

Throughout the drawings, like reference numerals will be understood to refer to like parts, components, and structures.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope as defined in the claims. In addition, descriptions of well-known functions and constructions may be omitted for clarity and conciseness

The terms and words used in the following description and claims are not limited to the bibliographical meanings, but, are merely used by the inventor to enable a clear and consistent understanding of the embodiments described herein. Accordingly, it should be apparent to those skilled in the art that the following description of example embodiments of the system and method for entity based position assignment is provided for illustration purpose only and not for the purpose of limiting the scope as defined by the appended claims and their equivalents.

Generally, the present disclosure provides embodiments of a method and system for entity based position assignment. The system retrieves position data related to the positions that are accessible to entities associated therewith. The system further retrieves entity data related to each entity that is to be assigned a position. The system further retrieves or determines rules intended to be followed in assigning entities to positions. The system analyzes the retrieved data and determines a desirable arrangement based on the position data, the entity data, and the rules.

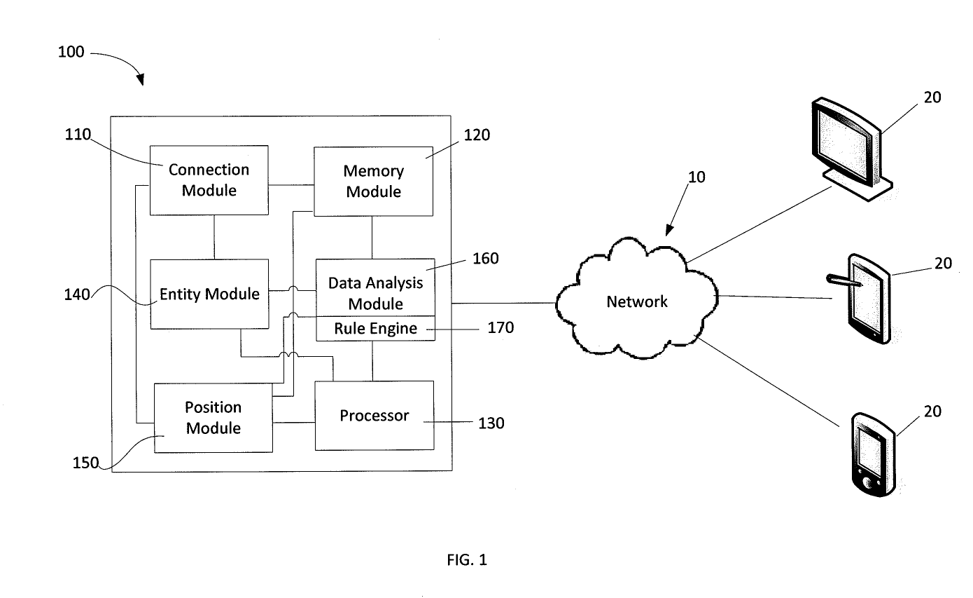

FIG. 1 illustrates a system 100 for entity based position assignment according to an example embodiment.

Referring to FIG. 1, the system 100 may be connected to a network 10, for example the Internet, a Local Area Network (LAN), a Wide Area Network (WAN), a Personal Area Network (PAN), an enterprise network, a Virtual Private Network (VPN), or the like. The network 10 connects user computing devices 20 to the system 100. Users may access the system 100 through a plurality of computing devices 20, for example, desktop workstations, laptop computers, tablet computers, smart phones, or the like. In some cases, the system 100 may reside on a local computing device 20 and the user will connect directly to the system and not connect via the network 10.

The system includes a connection module 110, a memory module 120, a processing module 130, an entity module 140, a position module 150, a data analysis module 160, and a rule engine 170.

The connection module 110 is configured to provide network connectivity to the system 100. The connection module 110 transmits data to and receives data from the network 10.

The memory module 120 is configured to store data received from the other modules of the system 100 and data received from external sources. As an example, the memory module 120 may be a database, or the like.

The processing module 130 is configured to execute the instructions of the system 100 and modules. In some cases, the processing module 130 may be the processing module for the whole system. In other cases, a separate processing module 130 may be included for each of the modules in the system 100. The processing module may be, for example, a central processing unit, or the like.

The entity module 140 is configured to retrieve and determine entity data such as, for example, entity attributes, entity preferences, and the like. The entity module 140 includes an input component configured to retrieve entity data from a plurality of sources such as, for example, the memory module 120, the users' computing devices 20, external network devices (not shown), or the like.

The position module 150 is configured to retrieve and determine position data such as, for example, position attributes, position requirements, or the like. The position module 150 includes an input component configured to retrieve data from a plurality of sources such as, for example, the memory module 120, the users' computing devices 20, external network devices (not shown), or the like.

The entity module 140 and position module 150 are operatively connected to a data analysis module 160. The data analysis module 160 is configured to review and analysis entity data and position data to determine a desirable arrangement wherein each entity is assigned to a position. The data analysis module 160 may include a rule engine 170 which is configured to ensure rules with respect to entity and position assignment are followed. In some cases, the rule engine may store the rules or may retrieve rules stored in the memory module 120. The data analysis module 160 is configured to query and retrieve the data stored by the memory module 120. The data analysis module 160 is further configured to weight or rank each position based on the retrieved position data.

In some cases, the entity data and position data may be retrieved from the memory module 120 and may include data that has been stored locally. In other cases, the entity module 140 and position module 150 may retrieve data from the user's computing devices 20 or from third party network devices (not shown). It is intended that the system 100 retrieves entity data that provides details and rules with respect to the placement of each entity. It is further intended that the system 100 retrieves position data that provides data as to amenities, conditions and further attributes related to each available position in order for the system to determine a desirable arrangement for each entity to be placed into a position.

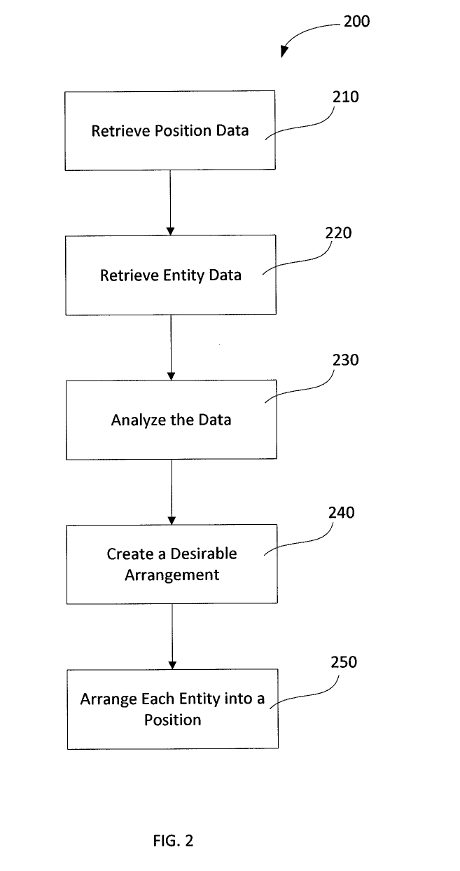

FIG. 2 illustrates an example of a method 200 for entity based position assignment according to an example embodiment.

Referring to FIG. 2, at 210, the position module 150 retrieves position data. The position data may be retrieved from a plurality of sources such as, for example, the user's computing device 20, a third party network device, the memory module 120, or the like. At 220, the entity module 140 retrieves entity data. The entity data may also be retrieved from a plurality of sources similarly to the position data. In some cases, the entities may be individuals, and the entity data may include individual preferences; individual attributes; individual special requirements; individual achievements; individual attendance; or individual participation.

Although shown consecutively, it will be understood that the data may be retrieved concurrently or in any predetermined order. In some case, the entity module 140 and position module 150 may store the entity data and position data in the memory module 120 after retrieving the data.

At 230, the data analysis module 160 analyzes the data. Each available position may be ranked or weighted with respected to the retrieved position data. The data analysis module 160 may retrieve and apply rules from the rule engine 170. In some cases, the data analysis module 160 may pass the data to the rule engine 170 for the rule engine 170 to apply the rules associated with the data.

At 240, with the application of the rules to the position data and entity data, the system 100 is configured to arrange the entities into positions to create a desirable arrangement. The desirable arrangement is intended to improve (e.g., optimize) the placement of the entities in that the greatest number of rules and requests with respect to aligning the entity preferences and position attributes are met. The desirable arrangement is further intended to meet any special criteria as determined by the data analysis module 160 in review of the entity data, position data, and rules.

At 250, each entity is assigned a position according to the desirable arrangement determined by the system 100.

In some cases, the entity data may include entity preferred location. The system 100, when determining a desirable arrangement may rank the entity preference as an important criterion that may be given precedence over the rules related to entity position. In other cases, the system 100 may consider entity preference equally in ranking as each rule and may determine a desirable arrangement based on merging entity preference with the rules. In still other cases, the system 100 may only consider entity preference after the system 100 has ensured that the desirable arrangement conforms to the rules.

In a specific example, the system 100 is configured to allow instructors to assign seats to students within a classroom layout.

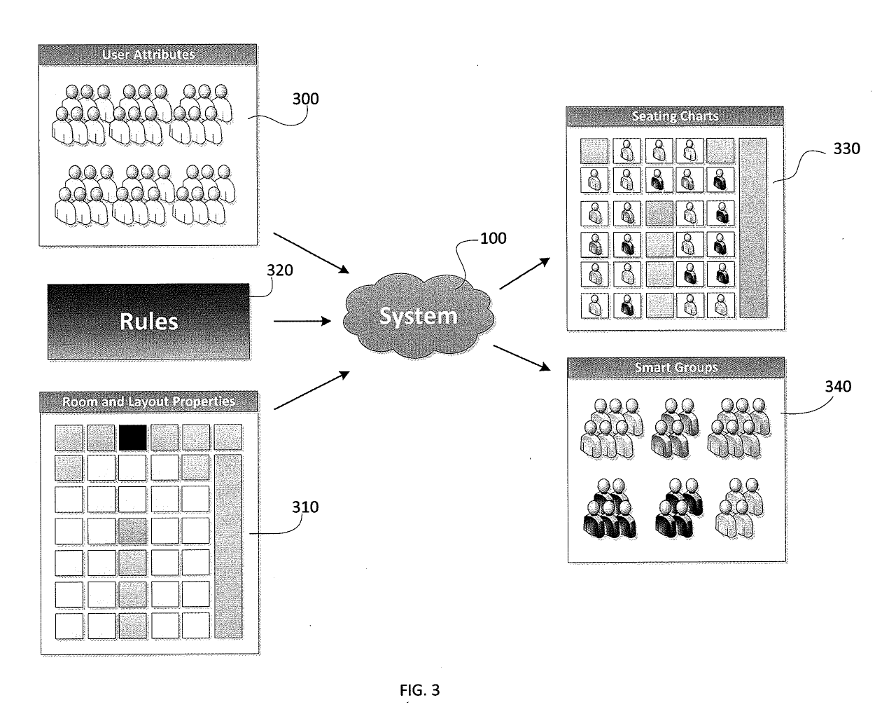

FIG. 3 illustrates a system for entity based position assignment in a classroom example according to an example embodiment.

Referring to FIG. 3, the system 100 with the inputs and outputs in a classroom setting is illustrated. The system 100 retrieves entity data, or student attributes 300. Student attributes 300 may include, for example:
participation by the student in a current and/or previous classes;
the number of cold calls received and/or answered correctly;
the student's attendance record;
the enrollment date of the student;
any membership in various groups;
the student's enrollment in various sections;
the student's academic history, for example the student's grades, achievements, competencies, or the like;
the student's profile attributes, for example, gender, culture, language, country, disabilities or impairments, or the like;
any employment experience;
the student's learning style;
etc.

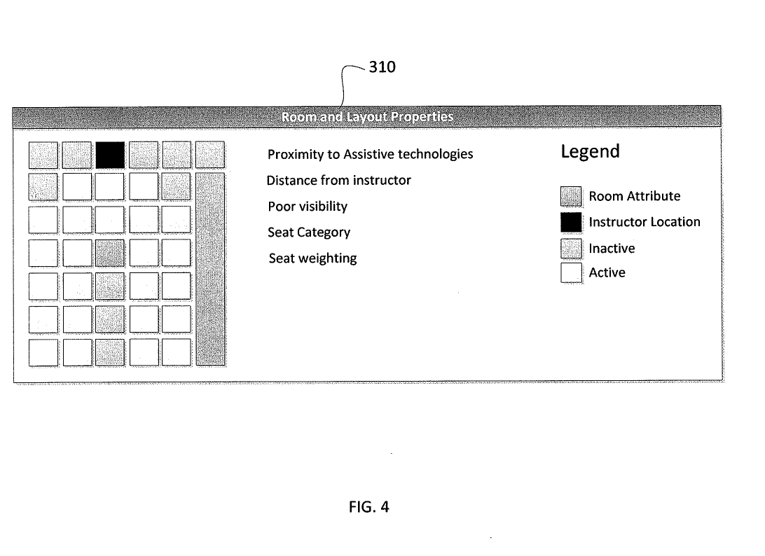

FIG. 4 illustrates position data according to a system for entity based position assignment such as, for example, the system illustrated in FIG. 3.

Referring to FIG. 4, position data 310 is retrieved by the position module 150. In the classroom setting, position data may include room and layout properties, for example:
seating arrangement and number of seats;
location of instructor;
room amenities, for example, location of speakers, wheelchair access, available equipment, or the like;
fill method, for example, random distribution, sparse layout, ordered distribution, or the like;
room attributes;
etc.

The system 100 retrieves the student attributes 300 and position data 310. The system 100 further retrieves rules 320. The rules 320 may include specific rules for a particular student or position or may include rules related to the instructor preferences or other criteria as described herein. The rule engine 170 may further determine special criteria based on the entity data or position data, for example, whether any student must sit in a particular location as the student requires certain equipment for accessibility reasons.

In some cases, the rule engine 170 may generate rules based on position weighting. In some cases, position weighting may be retrieved as part of the position data. In other cases, position weighting may be a combination of position data retrieved by the position module 150 and analyzed by the data analysis module 160 and rules executed by the rule engine 170 to determine the weighting of each position. In a classroom setting, position weighting may be a weighting for the seats available in the classroom. In this example, the position weighting for a seat may include aspects such as instructor proximity; seat accessibility; seat location to resources or equipment; or the like.

In some cases, the position weighting may be an aggregate weighting. Each position may be identified by a plurality of position data and each position property may be separately weighted. The aggregate of the weighting of each position property may be the position's overall weighting. For example, in a classroom a seat that is in the front may be given a specific weighting, the seat may also be given a weighting as to how close the seat is to assistive technology and the seat may receive a third weighting with respect to whether the seat is at the center or the side of the classroom. The overall seat weight may be the aggregate of the seat weightings. The aggregate of the seat weighting as well as each weighting per data element may be used in determining the desirable arrangement.

In this example, with the input of user attributes, rules and position data, the system 100 is configured to determine a desirable arrangement and assign each student into a desirable position. In this example, the output from the system 100 may be a seating chart 330 where the students are arranged according to the rules and the data received by the system 100. The system 100 may further output a division of the students into groups 340 wherein each group has been assigned students in view of the rules determined by the rule engine and the student attributes. In some cases, the seating chart 330 may be a layout that seats the students according to the groups 340 determined by the system. In other cases, an instructor may wish to have a seating chart 330 that includes one desirable arrangement of the students and a separate student group arrangement which positions the entities into groups according to different rules. A plurality of desirable arrangements is possible depending on the rules and instructor preferences and criteria specified.

In some cases, the instructor location may be considered position data, and may be used in determining a desirable arrangement. In other cases, the instructor may be an entity to be positioned by the system. The instructor, as an entity, may be defined by the entity data and may be positioned based on instructor preference, location of technology, or to maximize number of student entities to be positioned in proximity to the instructor. For example, in some cases the instructor may wish to stand at the front of the class, while in more interactive classes, the instructor may wish to have students positioned around the instructor location.

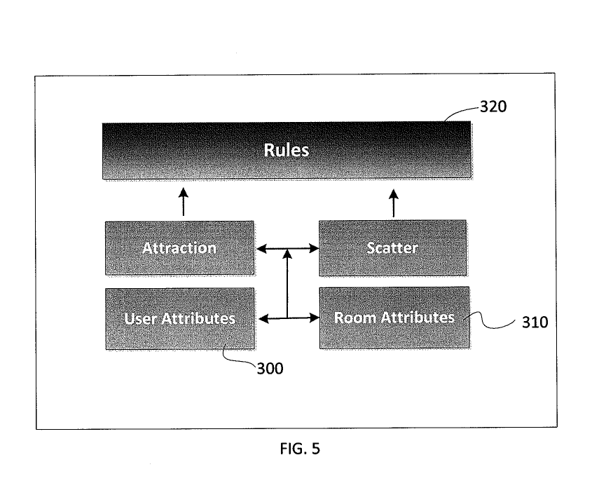

FIG. 5 illustrates rule generation according to a system for entity based position assignment such as, for example, the system illustrated in FIG. 3.

Referring to FIG. 5, rules are generated based on the student attributes 300 and the position data 310. In certain cases, the rules may be attraction based, for example placing students in close proximity or in seats weighted higher with respect to particular equipment. For example, students with visual or hearing impairments might sit closer to assistive technology, students with lower overall grades or younger students may sit closer to the front of the class room, students with common interests may sit near each other, or students with similar learning styles sit near each other with less than two seats between them.

In some cases, the system 100 is intended to create a diversified arrangement, where entities with similar entity status are scattered throughout the available positions to create a desirable arrangement. For example, students with similar age and gender may be scattered through the classroom, students may sit near other who are of a different cultural background, or the like. In another example, students with lower performance may sit near students who perform at a higher level.

Once the entity data and position data have been retrieved, the system 100 may assign each entity to a position based on the data and the defined rules. The data analysis module 160 may further determine layout attributes or position arrangement in order to disperse the entities into positions. In some cases, the system 100 may include a fill method, for example the entities may be dispersed randomly, sparsely, orderly or in another manner. In other cases, the position data may include categories or section for various positions and the entities may be first assigned a category or section, and than may be arranged by category or section. For example, in a classroom setting, the position data may include layout details, such as whether a seat is located in the front, back or side of the classroom. Seats may be assigned categories based on the location; students may first be assigned to categories, for example all younger students at the front. After the students have been assigned to a category, the students may be placed in a desirable arrangement within the category.

In some cases, the system 100 may determine a desirable arrangement and may continue to update or change the desirable arrangement on any change of entity data, position data and previous desirable arrangements. For example, the system 100 may determine a desirable arrangement prior to the start of each class section and may assign students into different seats or position. By rearranging the students, the system 100 can redistribute students that have been found to be underperforming in the current arrangement or redistributed students to ensure students interact with different individuals than in previous arrangements.

In other cases, the system 100 may amend the desirable arrangement on a predetermined basis, for example, once a week or once a month. In still other cases, the system 100 may amend the desirable arrangement on a triggering event, for example a predetermined change in entity or position data. For example, a student failing (e.g., or achieving below a predetermined threshold) a test or assignment may be a triggering event on which the system 100 determines a new desirable arrangement placing the failing student in a higher weighted position. In another example, if the position data is changed such that a previously occupied position has been removed, the system 100 may reconfigure a new desirable arrangement. In a workplace example, a previously occupied cubicle may be re-allocated to storage and the system 100 may reposition employee entities into a new desirable arrangement.

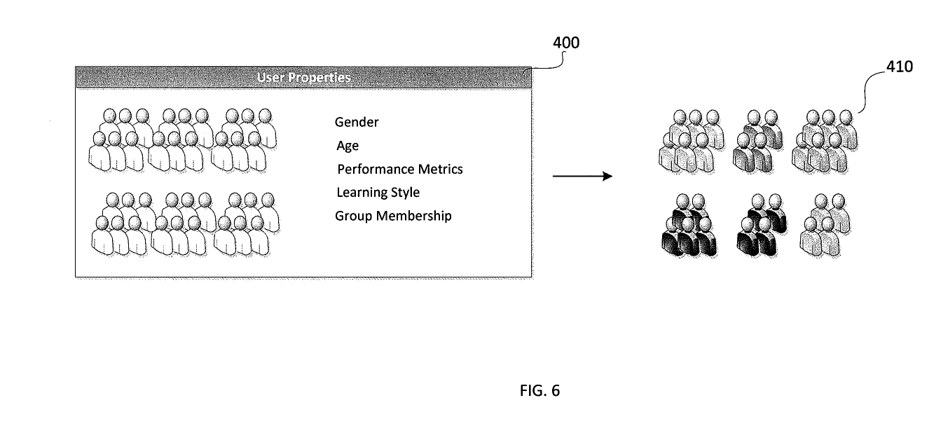

FIG. 6 illustrates entity organization according to a system for entity based position assignment such as, for example, the system illustrated in FIG. 3.

Referring to FIG. 6, the entities may be individuals with corresponding entity data 400 and the requested position assignment may be to assign the individuals into groups 410, for example assigning students into working groups. In this example, entity data 400 may include user attributes or user properties such as gender, age, performance metrics, learning style, group membership, and the like.

Position data in this example may be determined or retrieved and may include group attributes, for example, a number or a range of individuals per group, number of groups, fill method, and the like. If the position data details that groups 410 are to include between 4 and 6 individuals and are to be filled sparsely, the system 100 is intended to determine a desirable arrangement containing groups with the least number of individuals per group. In other cases, such as in the example shown in FIG. 6, the groups may be dispersed randomly, such that some groups have 4 individuals, some 5 individuals and still others have 6 individuals. The system 100 may also retrieve rules in relation to the group selection to be used in determining the desirable arrangement. For example, it may be preferable to have individuals from different cultural backgrounds in the same group. The groups may further include rules regarding the performance metrics, ages and past group experience to determine the desirable arrangement. In some cases, the system 100 will determine a diversified desirable arrangement with respect to multiple rules reviewed by the rule engine 170.

In some cases, the system 100 may be further configured to allow for an administrator to override the desirable arrangement and manually move entities into different positions. For example, an instructor may wish to manually tweak a specific classroom layout. In some cases, the system 100 may notify the administrator on moving the entity that the movement may reduce the optimal desirable arrangement and may further notify the administrator of the rules that are less optimized by the movement of the entity.

In some cases, the system 100 may monitor entities assigned to positions and may retrieve feedback from the entities. For example, the system 100 may be used to assign students to a classroom layout and the system 100 may solicit feedback from the student with respect to the currently assigned position. The student may rank the position and the student ranking may be included in the position weighting for determining a new desirable arrangement. In some cases, the student may provide feedback requesting a new position as the current position, although conforming to the rules, may not be appropriate to the student for another reason, for example, the student may have minor hearing difficulties that have not been previously recorded in the collected entity data. The feedback may be stored in the memory module 120 for use by the system 100 in future entity based position assignment.

In one example, the system 100 may be used in a Masters of Business Administration (MBA) environment. Typically, in an MBA environment it is beneficial to create diverse working groups wherein the students in each group have varied background and employment experience. In this case, the system 100 may determine entity data such as a student's background, undergraduate degree, past employment history, cultural background and the like. The system 100 may then determine an entity's position for example, in a seating arrangement or in a group project. The system 100 is intended to optimize the diversity with respect to the students and their assigned positions.

In another example, the system 100 may allow an administrator, such as an instructor, to define the entity data to be used by the system 100. In some cases, the administrator may redefine a user attribute in order to gather a specific data set for use in entity based position assignment. In other cases, the administrator may define a new type of entity data to be retrieved and analyzed by the system 100. The system 100 is intended to allow for an expandable database of entity data and position data and is intended to be flexible in allowing for specific types of data to be collected and used in the data analysis to determine a desirable arrangement. For example, one instructor may want to include user data as previous group membership with other students to create groups which consist of as many different group members when defining new groups. Another instructor may instead rely heavily on user preferences when assigning students to positions or groups and may not wish to include previous group membership as part of the data to be analyzed.

In yet another example, the system 100 may be used as an aid in a virtual environment, wherein the available positions may be used more as a guide than represent physical locations. In some cases, the system 100 may assign students into positions that may be displayed on a computing device for an instructor. Although the positions do not correspond to physical positions, the instructor may find a display of a representation of a seating chart helpful in not only learning about each student but also in determining strengths and weaknesses of the students and dividing students into group. In this case, as in the case where positions represent physical locations, the instructor or administrator may edit the desirable arrangement by moving entities between positions.

The system 100 may also be used in an enrollment situation wherein the entities may be students but the positions may be available space in class sections. The system 100 may retrieve entity data for each student, for example, cultural background, prior educational performance, employment history and the like. The system 100 may further retrieve position data related to class sections, for example, a number of sections to be held, the number of students per section, and the like. The rule engine 170 may further retrieve and determine if any rules relate to the assignment of students into specific classroom sections. The system 100 then assigns the students into class sections based on the rules and the retrieved data.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a non-transitory machine-readable medium (also referred to as a computer-readable medium, a processor-readable medium, or a computer usable medium having a computer-readable program code embodied therein). The non-transitory machine-readable medium can be any suitable tangible, non-transitory medium, including magnetic, optical, or electrical storage medium including a diskette, compact disk read only memory (CD-ROM), memory device (volatile or non-volatile), or similar storage mechanism. The non-transitory machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the non-transitory machine-readable medium. The instructions stored on the non-transitory machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for assigning positions, the method comprising:
retrieving position data related to each position of a plurality of positions;
retrieving data related to each entity of a plurality of entities, wherein each entity is to be assigned to one of the plurality of positions;
determining a desirable arrangement based at least in part on the position data and the entity data; and
arranging each entity in a corresponding desired position within the desirable arrangement.

2. The method according to claim 1, further comprising determining a position weighting for each of the plurality of positions.

3. The method of claim 1, wherein the determining of the desirable arrangement comprises:
determining rules corresponding to the entity data and position data; and
determining a desirable arrangement based on the rules.

4. The method according to claim 1, wherein the position data is based on at least one of:
location of each position;
proximity to equipment; and
accessibility of each position.

5. The method according to claim 1, wherein each entity is an individual.

6. The method according to claim 5, wherein the entity data is based on at least one of:
individual preferences;
individual attributes;
individual special requirements;
individual achievements;
individual attendance; and
individual participation.

7. The method according to claim 1, wherein the desirable arrangement is a diversified arrangement.

8. The method according to claim 7, wherein a diversified arrangement comprises entities with similar entity status scattered throughout the corresponding positions in the desirable arrangement.

9. The method according to claim 1, wherein the desirable arrangement is an arrangement in which special requirement criteria are met.

10. The method according to claim 1, further comprising:
allowing a user to edit the desirable arrangement.

11. The method according to claim 1, further comprising:
displaying the desirable arrangement on a network enabled device.

12. A system for entity based position assignment, the system comprising:
a position module configured to retrieve position data relating to each position of a plurality of positions;
an entity module configured to retrieve entity data relating to each entity of a plurality of entities, wherein each entity is to be assigned to a position; and
a data analysis module configured to determine a desirable arrangement based at least in part on the position data and the entity data and further configured to arrange each in a corresponding desired position within the desirable arrangement.

13. The system in claim 12, wherein the data analysis module is further configured to determine a position weighting for each of the plurality of positions based on the position data.

14. The system of claim 12, further comprising a rule engine configured to determine rules corresponding to the position data and the entity data, wherein the rules may be used in determining the desirable arrangement.

15. The system according to claim 12, wherein the data analysis module is further adapted to arrange each entity into a position based on the desirable arrangement.

16. The system according to claim 12, wherein the position module further comprises an input component adapted to collect position data and store the position data in a database.

17. The system according to claim 12, wherein the entity module further comprises an input component adapted to collect the entity data store the entity data in a database.

18. The system according to claim 12, further comprising a display module adapted to display the desirable arrangement on a network enabled device.

19. A system for automated seat arrangement in a classroom, the system comprising:
a position module adapted to capture data relating to seating positions in the classroom;
an entity module adapted to capture data relating to students in the classroom;
a data analysis module adapted to determine a desirable seating arrangement based at least in part on the data relating to seating positions and the data relating to the students.

20. The system in claim 19, wherein the data analysis module is further configured to determine a position weighting for each seating position based on the data relating to seating positions in a class room.

21. The system of claim 19, further comprising a rule engine configured to determine rules corresponding to the data relating to seating positions in a class room and the data relating to the students in the classroom, wherein the rules may be used in determining the desirable seating arrangement.
